(19) United States
(12) Patent Application Publication
(10) Pub. No.: US 2026/0286051 A1
(43) Pub. Date: Sep. 24, 2026

(54) PROCESS FOR PRODUCING A HYBRID NON-ISOCYANATE-CONTAINING POLYURETHANE

(71) Applicant: nolax AG, Sempach Station (CH)

(72) Inventors: Vincent LUTZ, Seedorf (CH); Daniela ODERMATT-BAER, Oberkirch (CH)

(73) Assignee: nolax AG, Sempach Station (CH)

(21) Appl. No.: 19/154,475

(22) PCT Filed: Feb. 7, 2024
(86) PCT No.: PCT/EP2024/053080

§ 371 Date: Aug. 7, 2025

(30) Foreign Application Priority Data
Feb. 9, 2023 (EP) 23155855.2

(51) Int. Cl. C08G 71/04; B01J 31/02

(52) U.S. Cl. CPC C08G 71/04; B01J 31/0237; C08G 2150/00; C08G 2170/00

(57) ABSTRACT

The present invention relates to methods for producing a hybrid non-isocyanate polyurethane. Apart from this, it relates to kits of parts for producing a hybrid non-isocyanate polyurethane. Furthermore, it relates to hybrid non-isocyanate polyurethanes obtainable by one of the methods according to the invention. It also relates to the use of hybrid non-isocyanate polyurethanes for the production of a foam, a binder, an adhesive or a coating.

The present invention relates to methods for the production of a hybrid non-isocyanate polyurethane. Apart from this, it relates to kits of parts for the production of a hybrid non-isocyanate polyurethane. Furthermore, it relates to hybrid non-isocyanate polyurethanes obtainable by one of the methods according to the invention. It also relates to the use of hybrid non-isocyanate polyurethanes for the production of a foam, a binder, an adhesive or a coating.

Polyurethane refers to a class of polymers consisting of organic units linked by carbamate (or urethane) bonds. Unlike other common polymers, polyurethane is produced from a wide range of starting materials. This chemical diversity results in polyurethanes with different chemical structures, which lead to many different applications. These include hard and soft foams, paints and coatings, adhesives, electrical casting compounds and fibres such as elastane and polyurethane laminate.

Polyurethanes are alternating copolymers and are often produced by reacting an isocyanate with a polyol. Both the isocyanates and the polyols used to produce a polyurethane contain two or more functional groups per molecule.

Isocyanates are substances with respiratory sensitising properties and their production usually involves the use of phosgene. They are therefore subject to certain restrictions within the European Union (EU). This makes the use of isocyanates less attractive for the production of polyurethanes. This is one of the reasons why there is a demand for so-called non-isocyanate polyurethanes (NIPUS).

There are various methods for producing NIPUs in the prior art. The four most common synthesis approaches are the polyaddition of cyclic carbonates and polyfunctional amines; the polycondensation between a polycarbamate and a polyol or a polyamine; the ring-opening polymerisation of 6- or 7-membered cyclic carbamates; and rearrangement reactions, such as Curtius, Hofmann or Lossen rearrangements.

The polyaddition of cyclic carbonates and polyfunctional amines appears to be one of the most promising ways to produce NIPUs. Such polyurethanes are present in the form of polyhydroxy polyurethanes (PHUs), wherein primary and secondary alcohol groups are formed in addition to urethane bonds. NIPUs therefore differ chemically from polyurethanes produced with isocyanates (STACHAK, P. et al. Recent Advances in Fabrication of NIPU-based Composite Materials. Materials 2021, Vol. 14, p. 3497).

NIPUs can be modified by copolymerisation or used as matrices for the production of polymer composites with various additives, similar to their conventional counterparts. For example, hybrid NIPUs (H-NIPUs) can be produced by combining cyclic carbonates, polyfunctional amines and epoxides.

In the prior art, H-NIPUs are often produced in multi-step syntheses, for example by reacting a cyclic carbonate with a multifunctional amine to form a prepolymer in a first synthesis step and then processing and/or isolating the intermediate product(s). The prepolymer is then converted into an H-NIPU with a polyepoxide in a second synthesis step. The prepolymer produced first may also contain epoxides and cyclic carbonates, for example, and be reacted with a polyamine in a further step. This prevents reagents and by-products from the first synthesis step from negatively influencing the second synthesis step (CORNILLE, A. et al. A perspective approach to sustainable routes for non-isocyanate polyurethanes. Eur. Polym. J. 2017, Vol. 87, pp. 535 to 552).

Such a prepolymer comprising cyclic carbonates and epoxides is described in U.S. Pat. No. 9,102,829 B2 (NANOTECH IND INC, 11 Aug. 2015). This is produced by reacting epoxidised unsaturated fatty acid triglycerides at 100° C. to 140° C. with CO₂ to obtain carbonised-epoxidised unsaturated fatty acid triglycerides. The epoxides of the fatty acid triglycerides are thus partially converted into a cyclic carbonate to obtain the prepolymer. The prepolymer is then reacted in several steps with various compounds, each containing either one or more amine groups or epoxide groups, to obtain the desired crosslinking of the H-NIPU. The polymerisation takes place at room temperature. A disadvantage of this method is that the ratio between epoxide and carbonate groups in the prepolymer depends on the controllability of the carbonation reaction. Another disadvantage of this method is that several method steps with subsequent processing and/or isolation are necessary to convert the prepolymer to H-NIPU, in which various compounds are reacted with the product of the respective preceding step.

A further method for producing H-NIPU in several method steps is described in U.S. Pat. No. 7,989,553 B2 (NANOTECH IND INC, 2 Aug. 2011). In a first method step, a so-called modifier is produced, which consists of a linear PHU formed from the reaction between a primary amine and cyclic carbonate. This modifier is then mixed with an epoxide component and an amine component in a further method step. The mixture is stirred for 30 minutes at 50° C. and then poured into a mould, where it is stored at 15° C. to 30° C. for 7 days for polymerisation. Here too, the disadvantage is that several method steps are necessary to produce the desired H-NIPU.

Similarly, US2021032495 A1 (ZHOU, Q., 4 Feb. 2021) describes a multi-step method wherein an amine-terminated NIPU prepolymer is first produced from amines and cyclic carbonates at 100° C. In addition, an epoxy chain extender is produced from trimethylolpropane triglycidyl ether and an amine. The prepolymer is further reacted with the epoxy chain extender to form an H-NIPU.

The prior art also describes methods in which all components are mixed in a single method step without first producing a prepolymer. In such a case, this is referred to as a one-pot synthesis.

The production of an H-NIPU in such a one-pot synthesis is described by KE, J. et al. (Critical transition of epoxy resin from brittleness to toughness by incorporating CO₂-sourced cyclic carbonate. J. CO₂ Util. 2018, Vol. 26, pp. 302-313). In this process, an epoxide-containing compound is mixed with a compound containing cyclic carbonate groups and an organocatalyst. The resulting mixture is degassed at 75° C. for 20 minutes and an amine-containing compound is added to the degassed mixture. The mixture is poured into a mould and polymerised and cured first at 25° C. for 24 hours, then at 100° C. for 2 hours and finally at room temperature for 7 days. A disadvantage of this method is that the mixture must be heated for polymerisation despite the addition of a catalyst. This means that the method is not suitable, for example, for producing H-NIPUs that are applied to surfaces or cast into moulds that are not heat-resistant at the temperatures used in the method.

The same disadvantage arises from the method described by LAMBETH, R. H. et al. (Mechanical and adhesive properties of hybrid epoxy-PHU network polymers. Polymer 2019, Vol. 183, page 121881) for a one-pot synthesis of an H-NIPU. An epoxide, a cyclic carbonate and an amine are mixed. The mixture is poured into a mould and cured at 80° C. for 48 hours. This method cannot therefore be used if the mixture is cured in contact with a material that is not heat-resistant at the relevant temperatures.

The object of the invention is therefore to overcome the disadvantages of the prior art and to find an improved method for producing H-NIPUs. In particular, it must be possible to produce H-NIPUs in a one-pot synthesis and for the polymerisation reaction to take place at room temperature.

This object is achieved by the independent claims. The methods according to the invention are suitable for producing H-NIPUs without the disadvantages of the prior art mentioned above.

One of the methods for producing an H-NIPU according to the invention is characterised in that it comprises the following steps:
i. Preparing a mixture comprising at least one epoxide, at least one cyclic carbonate and at least one catalyst for catalysing the formation of C—N bonds involving the at least one cyclic carbonate;
ii. optionally: heating the mixture to dissolve the catalyst; and
iii. adding at least one amine to obtain a hybrid non-isocyanate polyurethane by reacting the mixture at room temperature.

The at least one epoxide, the at least one cyclic carbonate and the at least one amine are preferably multifunctional. The use of multifunctional compounds enables cross-linking. Monofunctional epoxides, cyclic carbonates and amines may be partially present.

The method steps according to the invention can be carried out in at least one reaction vessel which is suitable according to a skilled person, and which is sufficiently thermally and chemically resistant. It may, but need not, be a reaction vessel intended for chemical synthesis.

An epoxide is a compound that contains at least one epoxide as a functional group. A mixture comprising at least one epoxide means that the mixture comprises one or more compounds, each of which contains at least one epoxide as a functional group.

At least one compound present at room temperature in solid or liquid form is used as a catalyst, which is suitable for catalysing the C—N bond formation between the at least one cyclic carbonate and the at least one amine, which leads to the formation of a urethane group. Preferably, catalysts or organocatalysts are used which are sterically hindered in such a way that they themselves do not form a permanent covalent bond with any of the components used to produce the H-NIPU and thus become part of the polymer, but are as little sterically hindered as necessary so that the polymerisation reaction is still catalysed at room temperature.

Organocatalysts are organic molecules that can catalyse chemical reactions in the absence of metals or metal ions.

If the catalyst used is a solid, the mixture in step ii. can optionally be heated until the catalyst is dissolved. After cooling to room temperature, at least a major part of the catalyst remains in solution in the mixture according to the invention.

A cyclic carbonate is a compound containing at least one cyclic carbonate as a functional group. A mixture comprising at least cyclic carbonate means that the mixture comprises one or more compounds, each of which contains at least one cyclic carbonate as a functional group.

An amine is a compound containing at least one amine as a functional group. “At least one amine” means that at least one compound is added, each of which contains at least one amine as a functional group.

In the context of the present invention, room temperature refers to the temperature that normally prevails in inhabited rooms and in workrooms such as laboratories. This temperature is usually in the range between 17° C. and 23° C., wherein the range may be exceeded or not reached under certain circumstances (e.g. by ventilating a room or by direct sunlight entering a room). Within the scope of the present invention, room temperature is understood to mean a temperature that is not higher than 35° C., preferably not higher than 30° C., most preferably not higher than 25° C. A method step that is carried out at room temperature is, in particular, a step in which no external heat is supplied to the physical components of the step by means of a heat source specifically provided for this purpose.

Within the scope of the present invention, the term “or” in the phrase “and/or” is to be understood as an exclusive disjunction. “A or B” means that exactly one of the two statements is true (if the disjunction is true).

After adding the at least one amine in step iii., a polymerisation reaction occurs between the at least one cyclic carbonate, the at least one epoxide and the at least one amine, wherein the catalyst accelerates the polymerisation reaction. The polymerisation reaction comprises the reaction between the at least one cyclic carbonate and the at least one amine, wherein a urethane is formed as a functional group under C—N bond formation; the polymerisation reaction further comprises the C—N bond formation between the at least one amine and the at least one epoxide. The use of multifunctional compounds (>2 reactive functional groups in at least one component) as starting monomers enables the cross-linking of the resulting linear H-NIPUs.

It has surprisingly been found that a method for producing an H-NIPU carried out with the steps described can be carried out in a one-pot synthesis, wherein in particular step iii., in which the curing of the H-NIPU takes place by means of polymerisation and crosslinking of the added components, can be carried out at room temperature without external heat supply.

A skilled person understands a one-pot synthesis to be a chemical synthesis characterised in that, as far as possible, all the reagents required are mixed in a vessel or on a surface and then allowed to react. One-pot syntheses do not require the isolation of intermediate products.

Some prior art methods for producing H-NIPUs comprise method steps in which, for example, a prepolymer is produced, which is processed and isolated in order to separate by-products and/or reagents from the prepolymer before the prepolymer is mixed with at least one further component and reacted. These are therefore not one-pot syntheses. In contrast, the method of the present invention allows the production of an H-NIPU without, for example, having to produce and process a prepolymer. This is because it has surprisingly been found that, in the method of the present invention for example the reaction between the amine and the epoxide is not significantly inhibited by other components in the mixture when all components are present together. Similarly, no undesirable side reactions are observed that impair the H-NIPUs resulting from the method. Such a method saves time and energy in contrast to methods comprising non-one-pot syntheses. In addition, valuable resources are saved when fewer work steps, materials and chemicals such as solvents are required.

Other methods known in the prior art (including those that can be carried out in a one-pot synthesis) rely on at least the polymerisation step (often also referred to as the curing step) only leading to an H-NIPU with the desired thermal, mechanical and chemical properties when external heat is supplied by means of a heat source. However, it has surprisingly been shown that one-pot synthesis of H-NIPUs is also possible without heat supply at room temperature. The H-NIPUs produced according to the method of the present invention have, for example, sufficiently good mechanical properties to be used as adhesives for load-bearing components, even though the polymerisation step (step iii.) is carried out at room temperature. The properties of exemplary H-NIPUs are listed in the embodiments. The fact that the method, and in particular the polymerisation step (step iii.), can be carried out at room temperature has the advantage that the method is, firstly, more energy-efficient compared to methods in which heat must be supplied for several hours or days during the polymerisation step. Secondly, H-NIPUs produced according to the method of the present invention are also suitable for use in physical contact with materials that are not very temperature resistant. If the mixture is poured into a mould before the polymerisation step (step iii.), for example, or if a surface is coated with the mixture for bonding (as H-NIPUs are commonly used), it is irrelevant in the method of the present invention whether the mould or the surface has, for example, only a temperature resistance up to a certain temperature above room temperature, since the polymerisation step (step iii.) of the present invention does not require any external heat supply.

Without being bound to any theory, it is assumed that (as described above) catalysts which are sterically hindered to such an extent that they do not themselves become part of the polymer, but are nevertheless as little sterically hindered as necessary for the polymerisation reaction to still be catalysed at room temperature, are particularly suitable for the method of the present invention. Tertiary amines are particularly suitable as organocatalysts because they do not themselves become part of the polymer during polymerisation, unlike primary and, in some cases, secondary amines. Nevertheless, compared to other organocatalysts, tertiary amines are still sufficiently reactive to catalyse the polymerisation reaction at room temperature.

Surprisingly, organocatalysts that are capable of activating the carbonyl group of cyclic carbonates are particularly suitable. These organocatalysts include, for example, hydrogen bond donors such as thiourea and 1,5,7-triazabicyclo[4.4.0]dec-5-ene (TBD), which is present in protonated form under neutral conditions due to its high basicity.

Surprisingly, the use of a catalyst according to the invention prevents the formation of undesirable by-products caused by elevated temperatures. These by-products include oxazolidinones and ureas, which can be formed at elevated temperatures by the reaction between the alcohol groups of the H-NIPU and the intermediate products of the one-pot synthesis. Such intermediate products are particularly undesirable because their formation interrupts the polymerisation. This leads to insufficient polymerisation and insufficient cross-linking.

An additional advantage resulting from the method according to the invention is that the content of the at least one cyclic carbonate in relation to the at least one epoxide can be varied over a very wide range. The ratio between the at least one cyclic carbonate and the at least one epoxide can be between 5:95 and 95:5 in terms of the number of functional groups present without impairing the cross-linking of the resulting H-NIPU. The mechanical, thermal and chemical properties can therefore be adjusted by selecting a suitable ratio between cyclic carbonate and epoxide depending on the intended use. For structural applications (e.g. when using an H-NIPU as an adhesive for bonding load-bearing structures), a ratio of between 40:60 and 60:40 is preferable, a ratio of between 45:55 and 55:45 is even more preferable, and a ratio of 50:50 is most preferable.

The objects of the invention thus provide an improved method for manufacturing H-NIPUS.

In a preferred embodiment, step i. is carried out at room temperature.

In a further preferred embodiment, the mixture is cast or applied to a carrier material after the addition of the at least one amine and before obtaining the hybrid non-isocyanate polyurethane. The application can be carried out in particular using the techniques customary for polyurethanes, polyurea or epoxy adhesives. Possible methods include dispensing using static and dynamic mixers, (high-pressure) countercurrent mixers, bead application, injection processes, casting, spraying, spatula application, squeegee application, rolling, stamping, dipping and impregnation.

In a preferred embodiment, at least one filler is added. The at least one filler is selected from the group of mineral, organic and hybrid fillers. The mineral fillers are preferably chalk and/or talc, the organic fillers are preferably polymers and/or natural fibres, and the hybrid fillers are preferably “core-shell” particles.

In the sense of the present invention, a filler is an additive that increases the volume of a mixture of substances without changing the essential properties of the mixture.

In a further preferred embodiment, at least one dye is added.

In the sense of the present invention, a dye is a chemical compound that has the property of colouring other materials.

In a further preferred embodiment, at least one additive is added. The at least one additive is selected from the group consisting of stabilisers, processing aids, thickeners, emulsifiers, impact modifiers and flame retardants.

Within the meaning of the present invention, an additive is an additive which is added in a method for manufacturing a product in order to achieve or improve certain properties. Within the meaning of the present invention, the various additives are defined as follows: a stabiliser is added to a chemical compound or mixture to ensure its stability and slow down its decomposition; a processing aid can be, for example, a propellant for the production of a foam; a thickener is a substance capable of binding solvents such as water; an emulsifier serves to mix two immiscible liquids into a finely distributed mixture, known as an emulsion, and to stabilise it; an impact modifier increases the ability of a material to absorb impact energy and shock energy without breaking; and a flame retardant is a substance that is intended to limit, slow down or prevent the spread of fires.

The at least one filler and/or the at least one colourant and/or the at least one additive can be added before, after or during any step of the method according to the invention. Even during the polymerisation step (step iii.), it is possible to add these substances as long as the mixture is still stirrable. The desired amount of the substance to be added can be added all at once, in portions over a certain period of time or continuously over a certain period of time.

Surprisingly, it has been found that a variety of different fillers, dyes and additives can be added to the mixture during the method according to the invention without preventing the one-pot synthesis at room temperature and that the H-NIPU obtained still has the desired mechanical, thermal and chemical properties.

In a preferred embodiment, at least one primary amine is added. Preferably, this at least one primary amine is at least one aliphatic primary amine. Most preferred is an aliphatic primary amine selected from the group consisting of diethylenetriamine, at least one amine from the group of phenalkamines, or a combination thereof. The higher the reactivity of the at least one amine added in step iii. of the method according to the invention towards cyclic carbonates, the lower the required reaction temperature. Primary amines and, in particular, aliphatic primary amines exhibit particularly high reactivity in this context.

In a further preferred embodiment, the sum of the number of functional groups of the at least one cyclic carbonate (from step i. of the method according to the invention) and the number of functional groups of the at least one epoxide (from step i. of the method according to the invention) is in a ratio of between 0.1:1 and 6:1, preferably between 0.2:1 and 3:1, most preferably between 0.4:1 and 1.5:1 to the number of functional groups of the at least one primary amine (from step iii. of the method according to the invention). This ratio, X, can also be expressed by the equation

$$X = \frac{C + E}{A} \qquad ( 1 )$$

wherein C represents the number of functional groups of the at least one cyclic carbonate, E represents the number of functional groups of the at least one epoxide, and A represents the number of functional groups of the at least one primary amine.

Surprisingly, it has been shown that the excess amine often used in the prior art is not necessary to produce H-NIPUs in a one-pot synthesis. Formulations have been found with which a high strength of the cured H-NIPU of >5 MPa can be achieved with an approximately stoichiometric ratio (an approximate 1:1 ratio X). Such a strength of an H-NIPU adhesive is suitable, for example, for bonding structural components.

Preferably, at least one epoxide selected from the group consisting of primary, secondary and tertiary epoxides or a combination thereof is added. Even more preferably, at least one primary and/or one secondary epoxide is added. Most preferred is at least one epoxide selected from the group consisting of epichlorohydrin, di-functional glycidyl ether epoxy resin and trimethylol propane triglycidyl ether. The addition takes place in step i. of the method according to the invention. It has been shown that the epoxides can be selected from a wide range without impairing the production of H-NIPUs according to the method of the present invention.

It is further preferred to add at least one aromatic epoxide, wherein the aromatic epoxide preferably has a glass transition temperature, T_{g}, of at least 0° C., preferably at least 40° C., most preferably at least 100° C. The addition takes place in step i. of the method according to the invention. The desired glass transition temperature of the epoxy component depends on the intended use of the respective H-NIPU. Without being bound by any theory, H-NIPUs produced with an epoxy component having a glass transition temperature of approximately 0° C. generally have a similar strength to the removable adhesive of sticky notes. H-NIPUs with a glass transition temperature of the epoxy component of 40° C. or 100° C. have correspondingly higher strength. Such aromatic epoxides are suitable, for example, for the production of H-NIPUs with correspondingly high strength.

The glass transition temperature is measured in accordance with test standard “ASTM D5279” (as of 5 Aug. 2021). The peak position of the curve of the loss factor tan (8) of the dynamic mechanical analysis (DMA) corresponds to the glass transition temperature.

In a preferred embodiment, at least one cyclic carbonate is added which has a molecular weight of less than 600 g/mol, more preferably less than 400 g/mol, most preferably less than 300 g/mol. The addition takes place in step i. of the method according to the invention. Without being bound to a theory, a molecular weight of the at least one cyclic carbonate that is as low as possible has a positive influence on the reaction rate and the conversion of the H-NIPU polymerisation reaction. Among other factors, this enables one-pot synthesis at room temperature according to the method of the present invention. Trimethylpropanol tricyclocarbonate and polypropylene glycol biscyclocarbonate are particularly suitable, for example.

In a further preferred embodiment, the catalyst is an electrophile, preferably a hydrogen bond catalyst, more preferably a catalyst selected from the group consisting of thiourea and salts of thiourea. In another preferred embodiment, the catalyst is a basic nitrogen compound, preferably a sterically hindered amine, more preferably a tertiary amine, wherein the tertiary amine is preferably selected from the group consisting of
1,5,7-triazabicyclo[4.4.0]dec-5-ene;
7-methyl-1,5,7-triazabicyclo[4.4.0]dec-5-ene;
1,8-diazabicyclo[5.4.0]undec-7-ene;
1,5-diazabicyclo[4.3.0]non-5-ene;
triethylamine; and
a polyaminophosphazene, wherein the polyaminophosphazene is preferably P₄-t-Bu.

In a further preferred embodiment, the catalyst is a strongly basic but weakly nucleophilic catalyst.

The catalyst is particularly preferred to be a sterically hindered amine.

A hydrogen bond catalyst is a catalyst that relies on the use of hydrogen bond interactions to accelerate and control chemical reactions.

In the context of the present invention, a sterically hindered amine is an amine which is sterically hindered to such an extent that it does not itself become part of the polymer in the method according to the invention for producing an H-NIPU, but is nevertheless as little sterically hindered as necessary so that the polymerisation reaction is still catalysed at room temperature. Tertiary amines are particularly suitable as catalysts because they do not themselves become part of the polymer during polymerisation, unlike primary and, in some cases, secondary amines. Nevertheless, compared to other catalysts, tertiary amines are still sufficiently reactive to catalyse the polymerisation reaction at room temperature.

The skilled person understands P₄-t-Bu to be a short form for the compound (1-tert-butyl-4,4,4-tris-(dimethylamino)-2,2-bis-[tris(dimethylamino)-phosphoranylidenamino]-2Λ5, 4Λ5-catenadi-(phosphazene).

Another aspect of the invention relates to a kit-of-parts for the preparation a hybrid non-isocyanate polyurethane according to one of the methods of the invention. The kit-of-parts comprises a first component comprising at least one epoxide and a second component comprising at least one amine. The first component and/or a third component comprise at least one cyclic carbonate, and at least one component comprises at least one catalyst for catalysing the formation of C—N bonds with the participation of the at least one cyclic carbonate.

Within the scope of the present invention, a kit-of-parts is a number of components intended for use together to produce a finished product. A kit-of-parts usually contains all the components necessary for the production of the product and often also instructions and diagrams with instructions for use. The individual components are offered, for example, in a common outer packaging. However, individual components may also be packaged separately and/or offered together with an indication that the corresponding component(s) should be used with one or more other components of the kit-of-parts. A kit-of-parts can be packaged and/or offered with or without the utensils and tools required for processing. In the case of a kit-of-parts for the manufacture of H-NIPUs, such a tool may be, for example, a squeegee for applying the still liquid mixture to a surface before it hardens.

In the context of the present invention, the terms “first component” and “second component” do not mean that, in order to mix the two components, the first component must necessarily be placed first, for example in a mixing vessel, and then the second component added. The second component can just as well be placed first, followed by the addition of the first component.

All features described in the methods according to the invention also apply to the kit of parts according to the invention, which is manufactured according to a method according to the invention. In particular, as described above, at least one cyclic carbonate is preferably used, which has a molecular weight of less than 600 g/mol, more preferably less than 400 g/mol, most preferably less than 300 g/mol. In addition, a catalyst as described above is preferably used, particularly preferably a sterically hindered amine.

In the context of the present invention, the statement “at least one component comprises at least one catalyst” means that at least one catalyst is present in the first component, in the second component, in the third component, if present, in a fourth component or in a combination thereof.

Another aspect of the present invention relates to a hybrid non-isocyanate polyurethane, in particular in the form of a foam, a binder, an adhesive or a coating, obtainable by a method according to the invention. The coating is preferably a lacquer, a colouring agent or a plaster.

For the purposes of the present invention, the following definitions apply: A foam is a fine or colloidal distribution of a gas (disperse phase) in a liquid or a solid. A binder is a substance by means of which solids with a fine degree of dispersion (e.g. powder) are bonded to each other or to a substrate. An adhesive is a non-metallic substance that is capable of bonding materials through surface adhesion and its internal strength. A coating is used for coating. Coating is the application of a firmly adhering layer of formless material to a workpiece without significantly changing the geometry of the workpiece. A lacquer is a coating material that is applied thinly to objects and, through chemical and/or physical processes, forms a substantially continuous, solid film. A colouring agent is a substance or composition that imparts colour. Plaster is a moist, paste-like and usually granular mass used to coat exterior and interior walls, ceilings and, in exceptional cases, roofs and decorative objects.

It has been shown that H-NIPUs produced according to a method according to the invention have different properties to H-NIPUs of the prior art. In particular, it has been found that the cross-linking reaction at room temperature is incomplete in the method according to the invention despite the catalysts. This means that the H-NIPUs have a post-curing potential. A post-curing potential can be demonstrated by determining the T_{g} of the H-NIPU before and after heating the cured H-NIPU. For example, the H-NIPU is heated from 50° C. to 180° C. at a heating rate of 10° C./min. If the T_{g} increases by a few° C., for example by 10° C., because the polymer can still undergo post-crosslinking under these conditions, post-curing potential can be detected. Without being bound to any theory, it is assumed that for H-NIPUs from the prior art, the reaction conditions (in particular the elevated temperature) are selected such that the cross-linking is essentially complete and thus no significant post-curing potential is present. A post-curing potential can only exist if residual monomers are present from all components. This is particularly not the case with prior art methods in which at least one intermediate product, for example a prepolymer, is processed and/or isolated in an intermediate step. In such a case, residual polymers from the corresponding reaction step are usually removed, which makes post-curing potential of the finished H-NIPU impossible.

Preferably, the at least one epoxide, the at least one cyclic carbonate, the at least one amine or a combination thereof is/are a bio-based compound(s).

As is known in the technical field, a bio-based substance is a substance that is produced on the basis of renewable raw materials. A renewable raw material is an organic raw material that originates from agricultural, forestry or fishery production. In the context of the present invention, “based on renewable raw materials” means that at least one precursor of the at least one epoxide, the at least one cyclic carbonate or the at least one amine, which is used to produce the H-NIPU according to the invention, is a renewable raw material; and the at least one precursor can be converted into the at least one epoxide in at most one reaction step, into the at least one cyclic carbonate in at most two reaction steps and into the at least one amine in at most one reaction step.

Precursors of bio-based epoxides are preferably or are preferably a component of
vegetable oils, preferably soybean oil, linseed oil, rapeseed oil, or a combination thereof;
Saccharides, preferably isosorbides, furans, or a combination thereof;
phenols, preferably tannins, cardanol, or a combination thereof;
natural resins, preferably terpenes, rosin, natural rubber, or a combination thereof;
lignin and/or lignin derivatives; or
a combination thereof.

Precursors of bio-based cyclic carbonates are preferably or are preferably a component of
vegetable oils, preferably soybean oil, linseed oil, rapeseed oil, or a combination thereof;
saccharides, preferably furans;
phenols, preferably tannins and/or cardanol;
natural resins, preferably terpenes and/or natural rubber;
lignin and/or lignin derivatives; or
a combination thereof.

Precursors of bio-based amines are preferably or are preferably a component of
plant oils, preferably amino acids, fatty acids, grape seed oil, or a combination thereof;
sugar derivatives, preferably isosorbides, succinic acid, adipic acid, azelaic acid, glucose derivatives, alcohol derivatives, or a combination thereof;
phenols, preferably cardanol;
lignin and/or lignin derivatives; or
a combination thereof.

In a preferred embodiment, the hardened hybrid non-isocyanate polyurethane according to the invention has a tensile strength of at least 10 MPa, preferably at least 25 MPa, most preferably at least 40 MPa; an elongation at break of at least 5%, preferably at least 50%, most preferably at least 100%; a tensile shear strength of at least 5 MPa, preferably at least 8 MPa, most preferably at least 11 MPa; a storage modulus at 20° C. of at least 200 MPa, preferably at least 600 MPa, most preferably at least 1000 MPa; or a glass transition temperature, T_{g} Of at least 30° C., preferably at least 40° C., most preferably at least 50° C.; or a combination of these properties.

The tensile shear strength is measured in accordance with test standard “DIN EN 302-1:2013” (as of June 2013).

The tensile elongation properties are measured in accordance with test standard “DIN EN ISO 527-1:2019” (as of December 2019).

The storage modulus and glass transition temperature are measured in accordance with test standard “ASTM D5279” (as of 5 Aug. 2021). The peak position of the curve of the loss factor tan (δ) of the dynamic mechanical analysis (DMA) corresponds to the glass transition temperature.

The initial viscosity and pot life are measured in accordance with test standard “DIN EN ISO 10364” (as of June 2018).

The pot life is the time from mixing multi-component materials to the point at which processing (e.g. application or casting) must be completed.

Another aspect of the invention relates to the use of a kit of parts according to the invention for the production of a foam, a binder, an adhesive or a coating. The coating is preferably a lacquer, a colourant or a plaster.

The kit of parts according to the invention or the hybrid non-isocyanate polyurethane according to the invention is preferably used for structural applications in automotive engineering, shipbuilding, railway engineering, aircraft construction, in the construction of means of transport, in electronics, in metal construction, in mechanical engineering, in 3D printing, in timber construction, in the construction of facades, in roof construction, in floor construction, in furniture construction, in exhibition stand construction, stage construction, door construction, partition wall construction, as a rubber substitute, in logistics, container construction, tank construction, energy generation, in the manufacture of batteries, paints, displays, shoes, sports equipment, packaging, in particular food packaging, lacquers, plasters, adhesives or matrices for composites.

Another aspect of the present invention relates to the use
a cyclic carbonate, preferably a cyclic carbonate with a molecular weight of less than 600 g/mol, more preferably less than 400 g/mol, most preferably 300 g/mol;
an epoxide, preferably a primary, secondary or tertiary epoxide, even more preferably a primary or secondary epoxide;
a catalyst;
an amine, preferably a primary amine, more preferably an aliphatic primary amine; or
a combination thereof

in a method according to the invention.

Preferably, the catalyst used is an electrophile, preferably a hydrogen bond catalyst, more preferably a catalyst selected from the group consisting of thiourea and salts of thiourea. In another preferred embodiment, the catalyst is a basic nitrogen compound, preferably a sterically hindered amine, more preferably a tertiary amine, wherein the tertiary amine is preferably selected from the group consisting of
1,5,7-triazabicyclo[4.4.0]dec-5-ene;
7-methyl-1,5,7-triazabicyclo[4.4.0]dec-5-ene;
1,8-diazabicyclo[5.4.0]undec-7-ene;
1,5-diazabicyclo[4.3.0]non-5-ene;
triethylamine; and
a polyaminophosphazene, wherein the polyaminophosphazene is preferably P₄-t-Bu.

In a further preferred embodiment, the catalyst is a strongly basic but weakly nucleophilic catalyst.

The invention is explained in more detail below with reference to the following examples. The examples are not intended to limit the scope of the invention in any way.

Examples 1 to 3 comprise different methods of manufacturing H-NIPUS.

The following chemical compounds were used for the embodiments:
ITAPOX 70/30 (available from ddchem S.r.l, Mazzantica VR, Italy): liquid epoxy resin based on a mixture of 70% w/w bisphenol A and 30% w/w bisphenol F epoxy resins
SP-1P-0-004_500 (available from Specific Polymers, Castries, France): cyclic carbonate, poly(propylene oxide), α,ω-bis(cyclocarbonate), CAS 111570-03-7
DER 331 (available from Olin, Clayton MO, USA): epoxy reaction product between epichlorohydrin and bisphenol A; 5,5-dimethyl-3,7-dioxa-1,9(2)-bis(oxirana)-4,6(2,4)-dibenzenanonaphane, CAS 1675-54-3
SP-3-00-003 (available from Specific Polymers, Castries, France): cyclisches Carbonat, 4,4′-[[2-Ethyl-2-[[(2-oxo1,3-dioxolan-4-yl)methoxy]methyl]-1,3-propanediyl]bis(oxymethylene)]bis[1,3-dioxolan-2-one], CAS 147876-32-2
NC-514S (available from Cardolite Cooperation, Bristol PA, USA): epoxide, [[4-[1-heptyl-8-[3-(oxiranylmethoxy)phenyl]octyl]phenoxy]methyl]oxirane, CAS 68390-54-5
DER 741 (available from Olin, Clayton MO, USA): Epoxide, 2-[2,2-bis(oxiran-2-ylmethoxymethyl)butoxymethyl]oxirane, CAS 3454-29-3
GX-6004 (available from Cardolite Cooperation, Bristol PA, USA): amine; GX-6004 comprises ≤20.0% w/w cashew nut shell extract (typically comprising 63% w/w monofunctional cardanol and 11% w/w bifunctional cardol), 12.0% w/w to 18.0% w/w 1,3-benzenedimethanamine, 3.0% w/w to 7.0% w/w trimethylhexane-1,6-diamine, &lt; 0.9% w/w resorcinol (each as a percentage by mass of the total weight of the composition).

Example 1 (B1): 16 g ITAPOX 70/30 (available from ddchem S.r.l, Mazzantica VR, Italy) and 9.8 g SP-1P-0-004_500 (available from Specific Polymers, Castries, France) are placed in a 50 ml beaker and mixed with a speed mixer at 2000 rpm for 1 minute. Then add 0.3 g of 1,5,7-triazabicyclo[4.4.0]dec-5-ene (available from Sigma-Aldrich, St. Louis MO, USA) and stir at 2500 rpm for another 3 minutes. Place the beaker in an oven set to 80° C. for 20 minutes. After 20 minutes, the catalyst is completely dissolved. The mixture is removed again, cooled to room temperature and stirred again for 3 minutes at 2500 rpm. 3.9 g of diethylenetriamine (available from Huntsman, Salt Lake City UT, USA) is stirred in at 2000 rpm for 1 minute and the mixture is immediately poured or used for bonding.

Example 2 (B2): 9 g of DER 331 (available from Olin, Clayton MO, USA) and 14.8 g of SP-3-00-003 (available from Specific Polymers, Castries, France) are placed in a 50 ml beaker and mixed with a speed mixer at 2000 rpm for 1 minute. Then add 0.3 g of 1,5,7-triazabicyclo[4.4.0]dec-5-ene (available from Sigma-Aldrich, St. Louis MO, USA) and stir at 2500 rpm for another 3 minutes. Place the beaker in an oven set to 80° C. for 20 minutes. After these 20 minutes, the catalyst is completely dissolved. The mixture is removed again, cooled to room temperature and stirred again for 3 minutes at 2500 rpm. 6.2 g of diethylenetriamine (available from Huntsman, Salt Lake City UT, USA) is stirred in at 2000 rpm for 1 minute and the mass is poured immediately afterwards or used for bonding.

Example 3 (B3): 8 g DER 331 (available from Olin, Clayton MO, USA), 8 g NC-514S (available from Cardolite Cooperation, Bristol PA, USA), 0.3 g DER 741 (available from Olin, Clayton MO, USA), 3.6 g SP-1P-0-004_500 (available from Specific Polymers, Castries, France) and 3 g SP-3-00-003 (available from Specific Polymers, Castries, France) are placed in a 50 ml beaker and mixed with a speed mixer at 2000 rpm for 1 minute. Then add 0.3 g of 1,5,7-triazabicyclo[4.4.0]dec-5-ene (available from Sigma-Aldrich, St. Louis MO, USA) and stir at 2500 rpm for another 3 minutes. Place the beaker in an oven set to 80° C. for 20 minutes. After these 20 minutes, the catalyst is completely dissolved. The mixture is removed again, cooled to room temperature and stirred again for 3 minutes at 2500 rpm. Add 1.9 g of diethylenetriamine (available from Huntsman, Salt Lake City UT, USA) and 4.9 g of GX-6004 (available from Cardolite Cooperation, Bristol PA, USA) and stir at 2000 rpm for 1 minute using a, then pour the mixture immediately or use it for bonding.

Characterisation of the H-NIPUs from Examples 1 to 3

The H-NIPUs from examples 1 to 3 are characterised by their initial viscosity, pot life, tensile strength, elongation at break, tensile shear strength, storage modulus and glass transition temperature.

To produce the test specimens for the tensile elongation test, the masses produced in examples 1 to 3 (B1 to B3) are cast into moulds in the form of plates and, after hardening, the test specimens are punched out using a punching tool. The test specimens for the dynamic mechanical analysis (DMA) are also cut from these plates.

To produce the tensile shear test specimens from wood, the masses are spread onto a planed beech wood plate and pressed together with an overlap of 25 mm×12 mm and a force of 0.8 N/mm2 for 24 hours. Bonding takes place at 20° C. and 65% relative humidity.

To produce the aluminium tensile shear test specimens, the masses are spread onto an AlMg₃ plate and pressed together with an overlap of 25 mm×12 mm and a pressure of 0.2 N/mm² for 24 hours. Bonding takes place at 20° C. and 65% relative humidity.

After production, all mixtures are stored for 7 days at 20° C. and 65% relative humidity before characterisation.

The results of the characterisation are summarised in Table 1.

TABLE 1
Characterisation of H-NIPUs from examples 1
to 3 (B1 to B3); ¹planed wood, ²AlMg₃ bare.

| | B1 | B2 | B3 |
|---|---|---|---|
| Initial viscosity at 20° C. / Pa*s | 5.5 | 324.0 | 6.7 |
| Pot life at 20° C. / min | 5 | 6 | 13 |
| Tensile strength / MPa | 36.4 | 46.6 | 11.5 |
| Elongation at break / % | 6.2 | 9.0 | 108.9 |
| Tensile shear strength / MPa | 6.0¹⁾ | 9.8²⁾ | 6.9¹⁾; 11.9²⁾ |
| Storage module at 20° C. / MPa | 1192 | 1180 | 269 |
| Glass transition temperature T_{g} / ° C. | 51.6 | 49.6 | 35.7 |

Post-Curing Potential from B1

The post-curing potential of the cured H-NIPU from B1 was determined by heating the H-NIPU from 50° C. to 180° C. at a heating rate of 10° C./min. An increase in the glass transition temperature, T_{g} of 10° C. and thus a post-curing potential was observed.

### Example 4 (B4): Effects of the Molecular Weight of at Least One Cyclic Carbonate on the Curing of NIPUS

Four different cyclic carbonates (CC) were converted into a NIPU using the method according to the invention (B4.1 to B4.4). The four mixtures were cured at room temperature. For comparison, a separate sample of each mixture was also cured at elevated temperatures in an oven. The results for the quality of the curing and the glass transition temperature, T_{g} are summarised in Table 2.

TABLE 2
Effects of the molecular weight of cyclic
carbonate (CC) on the curing of NIPU.

| | | Curing in an oven | | Curing at room |
|---|---|---|---|---|
| | M_{w} (CC) | | T_{g} | temperature |
| | [g/mol] | Quality | [° C.] | Quality |
| B4.1 | 440 | Incomplete curing; | <9 | Incomplete curing; |
| | | stiff; not sticky | | slightly elastic; |
| | | | | not sticky |
| B4.2 | 480 | Incomplete curing; | <−3 | Incomplete curing; |
| | | slightly elastic; not | | slightly elastic; |
| | | sticky | | not sticky |
| B4.3 | 610 | N/A | N/A | Not cured |
| B4.4 | 770 | Not hardened; slightly | <−35 | Not cured |
| | | elastic; sticky | | |

In examples B4.1 and B4.2, the NIPU was produced with a cyclic carbonate with a comparatively low molecular weight (Mw) (B4.1:440 g/mol; B4.2:480 g/mol). The degree of curing is within the expected range, with incomplete curing occurring both at room temperature and in an oven. For comparison, the mixtures in examples B4.3 and B4.4 do not cure at all. In both examples, cyclic carbonates with a comparatively high molecular weight (B4.3:610 g/mol; B4.4:770 g/mol) were used. Since no epoxides were used in examples B4.1 to B4.4, the polymers formed are NIPUs and not H-NIPUs. However, there is no indication as to why the same conclusions cannot be assumed for H-NIPUs.

1. A method for the production of a hybrid non-isocyanate polyurethane, wherein the following steps are included:
i. Preparing a mixture comprising at least one epoxide, at least one cyclic carbonate and at least one catalyst for catalysing the formation of C—N bonds with the participation of the at least one cyclic carbonate; and
ii. and
iii. adding at least one amine to obtain a hybrid non-isocyanate polyurethane by reacting the mixture at room temperature.

2. The method according to claim 1, wherein step i. is carried out at room temperature.

3. The method according to claim 1, wherein after adding the at least one amine and before obtaining the hybrid non-isocyanate polyurethane, the mixture is cast or applied to a carrier material.

4. The method according to claim 1, wherein one or more of
at least one filler selected from the group consisting of mineral, organic and hybrid fillers;
at least one dye; and
at least one additive selected from the group consisting of stabilisers, processing aids, thickeners, emulsifiers, impact modifiers and flame retardants
is added.

5. The method according to claim 1, wherein at least one primary amine is added.

6. The method according to claim 5, wherein the sum of the number of functional groups of the at least one cyclic carbonate and the number of functional groups of the at least one epoxide is in a ratio of between 0.1:1 and 6:1 to the number of functional groups of the at least one primary amine.

7. The method according to claim 1, wherein at least one epoxide selected from the group consisting of at least one of a primary, secondary and tertiary epoxides is added.

8. The method according to claim 1, wherein the catalyst
is an electrophile; or
is a basic nitrogen compound; or
a strongly basic but weakly nucleophilic catalyst.

9. A kit-of-parts for the preparation of a hybrid non-isocyanate polyurethane according to claim 1, comprising
a first component comprising at least one epoxide; and
a second component comprising at least one amine;
wherein
one or both the first component and/or a third component comprise at least one cyclic carbonate; and
at least one component comprising at least one catalyst for catalysing the formation of C—N bonds involving the at least one cyclic carbonate.

10. A hybrid non-isocyanate polyurethane obtainable by a method according to claim 1.

11. The hybrid non-isocyanate polyurethane according to claim 10, wherein at least one of
the at least one epoxide;
the at least one cyclic carbonate; and
the at least one amine
is/are a bio-based compound(s).

12. The hybrid non-isocyanate polyurethane according to claim 10, wherein the cured polyurethane has at least one of a tensile strength of at least 10 MPa; an elongation at break of at least 5%; a tensile shear strength of at least 5 MPa; a storage modulus at 20° C. of at least 200 MPa; and a glass transition temperature, T_{g} of at least 30° C.

13. A method for the production of a foam, a binder, an adhesive or a coating a colouring agent or a plaster by using a kit of parts according to claim 9.

14. (canceled)

15. (canceled)

16. The method according to claim 1, wherein the at least one epoxide and the at least one cyclic carbonate are multifunctional.

17. The method according to claim 1, wherein the method comprises an additional step ii. between steps i. and iii. of heating the mixture to bring the catalyst into solution.

18. The method according to claim 1, wherein the at least one amine is multifunctional.

19. The method according to claim 5, wherein the at least one primary amine is an aliphatic primary amine.

20. The method according to claim 19, wherein the aliphatic primary amine is selected from the group consisting of diethylenetriamine and a phenalkamine.

21. The method according to claim 7, wherein at least one of a primary and a secondary epoxide is added.

22. The method according to claim 1, wherein the catalyst is a sterically hindered amine.
